(19) United States
(12) Patent Application Publication
(10) Pub. No.: US 2008/0088237 A1
(43) Pub. Date: Apr. 17, 2008

(54) Phosphor composition for plasma display panel and plasma display panel

(76) Inventors: Seung-Uk Kwon, Suwon-si (KR); Jin-Keun Jung, Suwon-si (KR)

Correspondence Address: ROBERT E. BUSHNELL, 1522 K STREET NW, SUITE 300, WASHINGTON, DC, 20005-1202, US

(21) Appl. No.: 11/902,666

(22) Filed: Sep. 24, 2007

(30) Foreign Application Priority Data
Sep. 28, 2006 (KR) 10-2006-0094929

(51) Int. Cl. H01J 17/49; B05D 5/06; C09K 11/00

(52) U.S. Cl. 313/586; 252/301.4 R; 427/64

(57) ABSTRACT

The phosphor composition for a plasma display panel includes a phosphor, a firing promoter, and a vehicle. The phosphor composition of the present invention can improve the luminous efficiency and luminance maintenance ratio of a plasma display panel and decrease the firing temperature without damage of a panel by completely removing impurities such as a binder and a solvent when forming a phosphor layer due to a firing promoter.

### CROSS-REFERENCE TO RELATED APPLICATION AND CLAIM OF PRIORITY

This application claims priority to and the benefit of Korean Patent Application No. 10-2006-0094929 filed in the Korean Intellectual Property Office on Sep. 28, 2006, the entire content of which is incorporated herein by reference.

### BACKGROUND OF THE INVENTION

(a) Field of the Invention

The present invention relates to a phosphor composition for a plasma display panel and a plasma display panel.

(b) Description of the Related Art

A plasma display panel is a display device that forms an image by exciting phosphor with vacuum ultraviolet (VUV) rays generated by a gas discharge in discharge cells. Since a plasma display panel is capable of forming a large, high-resolution screen, it is drawing attention as a next-generation thin display device.

At present, a generally used plasma display panel is a reflective, alternating current driven plasma display panel. On a rear substrate, phosphor layers are formed in discharge cells compartmentalized by barrier ribs.

In order to obtain a uniform and stable discharge of a plasma display panel, surface characteristics of a phosphor should be ensured, since phosphor discharge in a plasma display panel occurs at the surface of a phosphor. Therefore, a phosphor layer should be formed while maintaining the surface characteristics of the phosphor.

The phosphor layer is generally obtained by printing a phosphor slurry composition. In order to provide the phosphor slurry composition with a predetermined viscosity, it includes a binder such as an ethyl cellulose resin, a nitro cellulose resin, an acryl resin, and so on. However, if the resin or a solvent are not completely removed during the drying or firing process, they can remain as impurities in the plasma display panel, which causes an imperfect discharge and deteriorates the luminous efficiency.

The above information disclosed in this Background section is only for enhancement of understanding of the background of the invention and therefore it may contain information that does not form the prior art that is already known in this country to a person of ordinary skill in the art.

### SUMMARY OF THE INVENTION

One embodiment of the present invention provides a phosphor composition for a plasma display panel that can improve luminous efficiency and a luminance maintenance ratio of a plasma display panel by completely removing impurities such as a binder and a solvent when forming a phosphor layer.

Another embodiment of the present invention provides a plasma display panel including a phosphor layer made using the phosphor composition.

According to an embodiment of the present invention, provided is a phosphor composition that includes a phosphor, a firing promoter including SeO₂, and a vehicle.

The firing promoter may further include at least one oxide including an element selected from the group consisting of a group 6A element, a group 5B element, a group 6B element, a lanthanum-based element, and mixtures thereof. In one embodiment, the firing promoter may further include at least one oxide selected from the group consisting of V₂O₅, MoO₃, CeO₂, and mixtures thereof. In another embodiment, the firing promoter may further include all the oxides of SeO₂, V₂O₅, MoO₃, and CeO₂.

According to another embodiment of the present invention, provided is a plasma display panel that includes: a first substrate and a second substrate facing each other; discharge cells partitioned in a space between the first and second substrates; a phosphor layer disposed in the discharge cells and including a phosphor and a firing promoter including SeO₂; scan electrodes and sustain electrodes forming a discharge gap in each discharge cell; a dielectric layer covering the scan electrodes and sustain electrodes; and address electrodes disposed in a direction crossing the scan electrodes.

The phosphor composition for the plasma display panel according to the embodiments of the present invention can be applied to various structured plasma display panels, and a detailed description of different embodiments will follow. According to the plasma display panel according to a first embodiment, each of the scan electrodes and the sustain electrodes respectively includes belt shaped transparent electrodes extending in a direction crossing the address electrodes and a stripe shaped bus electrode electrically connected to the transparent electrode.

According to a second embodiment, the transparent electrodes are protrusion electrodes protruding inside the discharge cells.

According to a third embodiment, the protrusion electrodes include terminal end parts facing each other and providing a discharge gap, and a connecting part connecting the terminal end parts to the bus electrodes.

According to a fourth embodiment, the plasma display panel may further include groove parts formed on the dielectric layer between the scan electrodes and the sustain electrodes.

According to a fifth embodiment, the plasma display panel includes red, green, and blue discharge cells in order to display images. These three color discharge cells form one pixel unit. This embodiment provides a resolution of 1920×1080.

According to a sixth embodiment, the present invention provides a plasma display panel including: a first substrate; a second substrate facing the first substrate; first barrier ribs formed on the first substrate and covering sustain electrodes and scan electrodes; second barrier ribs partitioning discharge cells by assembling with the first barrier ribs; a phosphor layer disposed on the second barrier ribs and including a phosphor and a firing promoter; scan electrodes and sustain electrodes surrounding the discharge cells and extending in a certain direction and successively disposed on the first substrate facing the second substrate; and address electrodes disposed in a direction crossing the scan electrodes and sustain electrodes.

Another embodiment of the present invention provides a method for preparing a phosphor layer in a plasma display panel, including: preparing a phosphor composition comprising a phosphor, a firing promoter comprised of SeO₂, and a vehicle; coating the phosphor composition on barrier ribs of the plasma display panel; and firing the phosphor composition coated on the barrier ribs to remove the vehicle.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components.

FIG. 1 is an exploded perspective view of a plasma display panel according to a first embodiment of the present invention.

FIG. 2 is a top plan view showing the positional relationship of discharge cells and display electrodes of the plasma display panel illustrated in FIG. 1.

FIG. 3 is a top plan view showing the positional relationship of discharge cells and display electrodes of a plasma display panel according to a second embodiment of the present invention.

FIG. 4 is a top plan view showing the positional relationship of discharge cells and display electrodes of a plasma display panel according to a third embodiment of the present invention.

FIG. 5 is a top plan view showing the positional relationship of discharge cells and display electrodes of a plasma display panel according to a fourth embodiment of the present invention.

FIG. 6 is a cross-sectional view showing a cross-section cut along the □-□ line of FIG. 5.

FIG. 7 is an exploded perspective view showing a partial portion of a plasma display panel according to a sixth embodiment of the present invention.

FIG. 8 is a perspective view showing display electrodes of the plasma display panel illustrated in FIG. 7.

FIG. 9 is a top plan view showing the positional relationship of discharge cells and scan electrodes of the plasma display panel illustrated in FIG. 7.

FIG. 10 is a top plan view showing the positional relationship of discharge cells and sustain electrodes of the plasma display panel illustrated in FIG. 7.

FIG. 11 is a cross-sectional view showing a cross-section cut along the X-X line of FIG. 9.

FIG. 12 is a cross-sectional view showing a cross-section cut along the IX-IX line of FIG. 9.

FIG. 13 is a graph showing measurement results of thermo gravimetric analysis (TGA) of SeO₂, V₂O₅, MoO₃, and CeO₂ according to Experimental Examples.

### DETAILED DESCRIPTION OF THE INVENTION

The present invention relates to a phosphor composition including a firing promoter in order to completely remove a vehicle (including a binder and a solvent) that can generate impurities in the phosphor layer of the plasma display panel during the firing process.

Generally, the phosphor layer is obtained by coating (printing) a phosphor composition including phosphor and a vehicle including a binder and solvent on the predetermined parts (barrier ribs) and firing the same. During the firing process, the vehicle is supposed to be volatilized and removed. However, some of the vehicle is not volatilized. The solvent of the vehicle is easily removed, but the polymer resin for the binder is difficult to be removed by the conventional firing process. Even though such a firing process is performed, a residual carbon (C, CO, CH(29), CH(45), wherein CH is hydrocarbon and the numbers indicate molecule weight) may be incompletely removed and is usually remained due to the thickness and shape of the phosphor composition. Such residual carbon inhibits the light emitting properties of the phosphor surface and deteriorates the phosphor since it is chemically bound with the phosphor. As a result, the luminous efficiency and the luminance maintenance ratio of phosphors are deteriorated in the plasma display panel.

According to one embodiment of the present invention, this problem is solved by adding a firing promoter in the phosphor composition.

The phosphor composition includes phosphor, a firing promoter, and a vehicle.

The firing promoter helps the heat transfer throughout the phosphor composition during the firing process to cause debinding at a low temperature, and it prevents the phosphor material from deteriorating due to overheating. In addition, the firing promoter decreases the binding strength of the polymer resin to accelerate the debinding rate at the same temperature, and it helps remove the residual carbon that is remained polymer resin.

According to one embodiment, the firing promoter includes SeO₂. According to another embodiment, the firing promoter further includes at least one oxide including an element selected from the group consisting of a group 6A element, a group 5B element, a group 6B element, a lanthanum-based element, and mixtures thereof. For example, the oxide may be selected from the group consisting of V₂O₅, MoO₃, CeO₂, and mixtures thereof. In another embodiment, the firing promoter includes all of SeO₂, V₂O₅, MoO₃, and CeO₂.

When the firing promoter is added, the adding amount thereof is determined to be as much as required to provide the expected results.

According to one embodiment, the amount of firing promoter ranges from 0.1 to 10 wt % based on the total weight of the phosphor composition. According to another embodiment, it ranges from 0.1 to 5 wt.

For example, the amount of the firing promoter is selected from 0.1, 0.2, 0.3, 0.4, 0.5, 1, 1.5, 2, 2.5 3, 3.5, 4, 4.5, 5, 5.5, 6, 6.5, 7, 7.5, 8, 8.5, 9, 9.5, and 10wt %.

When the firing promoter is used at less than 0.1 wt %, the effect of adding the firing promoter is insufficient, yet when it is more than 10 wt %, the firing promoter inhibits the light emitting properties of the phosphor so that luminance is not improved.

As described, the firing promoter according to an embodiment of the present invention provides sufficient effects by being added in a small amount. Further, the firing promoter decreases the firing temperature of the phosphor composition from the range of 480 to 510° C. to the range of 400 to 460° C., so that it can effectively remove the impurities at a temperature that does not damage the plasma panel. As a result, the luminous efficiency and the luminance maintenance ratio are improved in the plasma display panel even though the same manufacturing process is performed and for the same duration.

The phosphor composition may be used for all the red, green, and blue phosphor compositions. The red phosphor may include (Y,Gd)BO₃:Eu, Y(V,P)O₄:Eu, (Y,Gd)₂O₃:Eu, or Y₂O₃:Eu; the green phosphor may include Zn₂SiO₄:Mn, YBO₃:Tb, or (Zn,A)₂SiO₄:Mn (A is an alkali metal); and the blue phosphor may include BaMgAl₁₀O₁₇:Eu, CaMgSi₂O₆:Eu, CaWO₄:Pb, or Y₂SiO₅:Eu. It may include any other red phosphors, green phosphors, and blue phosphors other than mentioned above that are conventionally used in the plasma display panel field.

According to one embodiment, the amount of phosphor ranges from 30 to 50 wt % based on the total weight of the phosphor composition. The phosphor may be used in the amount of 30, 35, 40, 45, or 50 wt %. When the phosphor is used in an amount of less than 30 wt %, luminance is deteriorated. On the other hand, when it is more than 50 wt %, the discharge space is too small to prevent an incorrect discharge.

The vehicle of the phosphor composition includes a binder and a solvent.

The binder may include at least one cellulose-based polymer or acryl resin such as ethyl cellulose or nitro cellulose, but it is not limited thereto. It may include any other binder used in the conventional phosphor composition. According to one embodiment, the amount of the binder ranges from 4.5 to 7 wt % based on the total weight of the phosphor composition. According to another embodiment, the amount of the binder may be added in the amount of 4.5, 5, 5.5, 6, 6.5, or 7 wt %. When the amount of the binder is out of the above range, the duration of the firing process is prolonged when forming the phosphor layer.

The solvent may include at least one selected from the group consisting of organic solvents such as butyl carbitol acetate, terpineol, ethyl carbitol, animal oil, and vegetable oil, but it is not limited thereto. It may include any solvent used in the conventional phosphor composition. The amount of the solvent is adjusted depending upon the amount of phosphor, a binder, and a firing promoter, and so does not need to be defined.

A plasma display panel includes: a first substrate and a second substrate facing each other; discharge cells partitioned in a space between the first and second substrates; a phosphor layer disposed in the discharge cells and including a phosphor made using the phosphor composition and a firing promoter including SeO₂; scan electrodes and sustain electrodes forming a discharge gap in each discharge cell; a dielectric layer covering the scan electrodes and sustain electrodes; and address electrodes disposed in a direction crossing the scan electrodes.

The phosphor composition for a plasma display panel can be applied to a plasma display panel having various structures.

Hereinafter, one embodiment of the present is illustrated in more detail with reference to the accompanying drawings, so that a person of an ordinary skill in the art can easily realize it. These embodiments, however, should not in any sense be interpreted as limiting the scope of the present invention. Hereinafter, the descriptions of the same reference numbers for each drawing are omitted.

Regardless of the types of the plasma display panel structure, the phosphor layer includes the corresponding colored phosphor and the firing promoter. The amount of the firing promoter ranges from 0.25 to 25 wt % based on the total weight of the phosphor layer. According to another embodiment, it ranges from 2.5 to 12.5 wt %. For example, the firing promoter may be present in an amount of 0.25, 0.5, 0.75, 1.25, 1.5, 2, 3, 4, 5, 6, 7, 8, 9, 10, 11, 12, 13, 14, 15, 16, 17, 18, 19, 20, 21, 22, 23, 24, or 25 wt %. The percent weight of the firing promoter in the phosphor layer is greater than the percent weight of the firing promoter in the phosphor composition because the organic solvent and the binder are removed from the phosphor composition during the firing process.

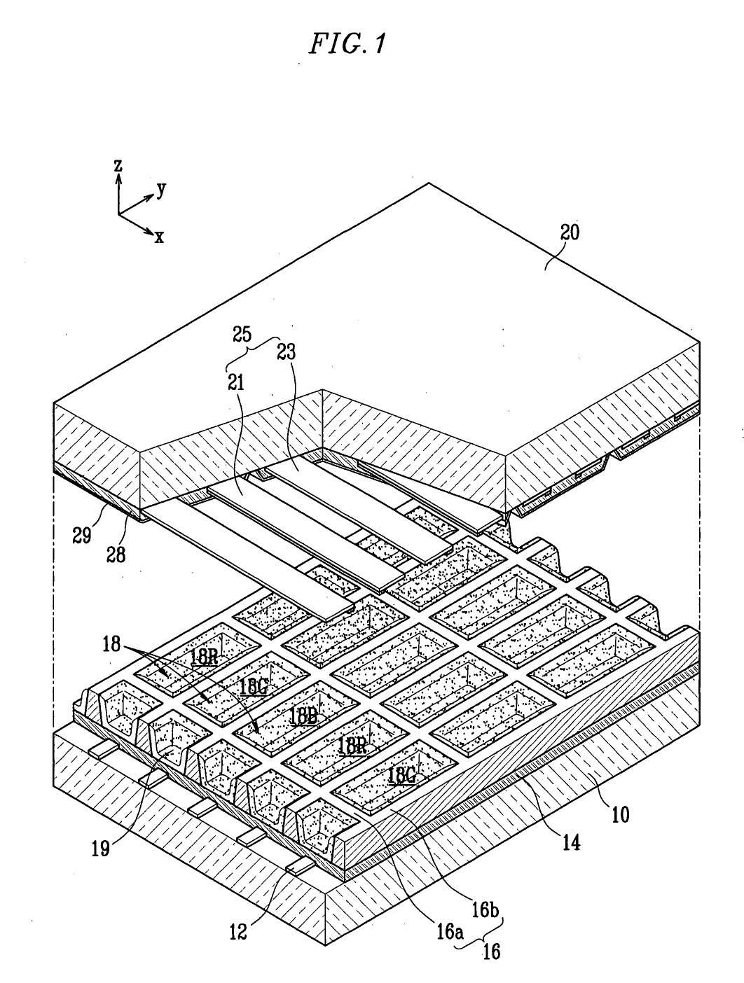

FIG. 1 is an exploded perspective view of a plasma display panel (PDP) according to a first embodiment of the present invention.

The PDP according to the first embodiment includes a front substrate 20, a rear substrate 10 facing the front substrate 20, and barrier ribs 16 partitioning the space between the front and rear substrates to form discharge cells 18. The discharge cells 18 form sub-pixels. Each pixel is composed of a plurality of sub-pixels, where the sub-pixel is a minimum unit displaying the image. Display electrodes 25 and address electrodes 12 are formed to correspond to each discharge cell 18. The display electrodes 25 and the address electrodes 12 are separated by a predetermined distance and are extended in respective directions to cross each other. The discharge cells 18 are located at the crossing points of the discharge electrodes 25 and the address electrodes 12.

The front substrate 20 is formed of a transparent material, such as glass, to transmit the light. The image is displayed on the front substrate 20 by the discharge of the discharge cells 18.

The display electrodes 25 are formed to correspond to each discharge cell 18. The display electrodes 25 may be formed in pairs each including a scan electrode 21 and a sustain electrode 23. The scan electrode 21 and the sustain electrode 23 of each pair have a predetermined distance therebetween to provide a discharge gap corresponding to a discharge cell 18. The scan electrodes 21 are operated with the address electrodes 12 to turn on the selected discharge cells 18, and the sustain electrodes 23 are operated with the scan electrodes 21 to discharge the selected discharge cells 18 during the maintenance period.

The display electrodes 25 are covered with and protected by a dielectric layer 28 formed of dielectric materials (for example, PbO, B₂O₃, SiO₂). The dielectric layer 28 prevents the display electrodes 25 from damage that is caused by collision of the charged particles.

The dielectric layer 28 may be covered by a protective layer 29 (for example, formed of MgO). The protective layer 29 prevents the dielectric layer 28 from damage caused by collision of the charged particles against the dielectric layer 28. It also releases second electrons to increase the discharge efficiency when the charged particles collide therewith.

The address electrodes 12 may be formed on the rear substrate 10 facing the front substrate 20. As shown, the address electrodes 12 extend in a direction (y-axis direction in FIG. 1) crossing the display electrodes 25 to correspond to each discharge cell 18. Accordingly, the entire address electrodes 12 form a stripe pattern on the rear substrate 10. The address electrodes 12 are operated with the scan electrodes 21 to turn on the selected discharge cells 18.

The address electrodes 12 are covered with and protected by a dielectric layer 14. Thereon, the barrier ribs 16 are formed to partition the discharge cells 18. The barrier ribs 16 are constituted with horizontal barrier ribs 16a extending in an x-axis direction in FIG. 1 and vertical barrier ribs 16b extending in a y-axis direction in FIG. 1.

The inside of the discharge cells 18 are provided with a phosphor layer 19 emitting the visible light for each color. The phosphor layer includes a phosphor and a firing promoter. The phosphor layer 19 is obtained by coating the phosphor composition on the bottom surface and the wall surfaces of the barrier ribs 16 partitioning the discharge cells 18, and firing the phosphor composition.

Red R, green G, and blue B phosphor layers 19 are respectively formed on the discharge cells 18. A set of a red discharge cell 18R, a green discharge cell 18G, and a blue discharge cell (B) forms one pixel.

The inside of the discharge cells 18 formed with the phosphor layer 19 is filled with a mixed discharge gas of neon, xenon, etc.

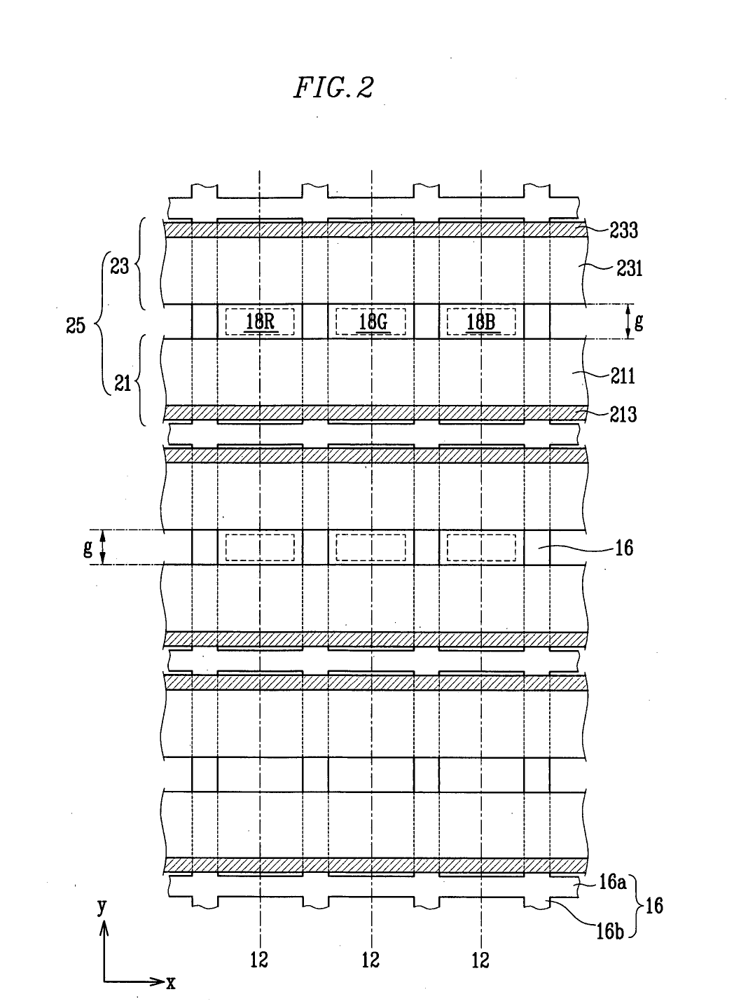

FIG. 2 is a top plan view showing the positional relationship of the discharge cells and display electrodes of the plasma display panel illustrated in FIG. 1.

The barrier ribs 16 include horizontal barrier ribs 16a extending in a first direction (x-axis direction in FIG. 2) crossing the address electrodes 12 and vertical barrier ribs 16b extending in a second direction (y-axis direction in FIG. 2) crossing the first direction.

The discharge cells 18 are partitioned by the barrier ribs 16a and 16b as a lattice between the front substrate 20 and the rear substrate 10. Discharge cells 18 for the same color are disposed in rows (y-axis direction in FIG. 2), and discharge cells 18 for the different colors are sequentially disposed in columns (x-axis direction).

A set of discharge cells 18 for red, green and blue disposed in a width direction, that is, a red discharge cell 18R, a green discharge cell 18G, and a blue discharge cell 18B, forms one pixel. The resolution of the PDP is determined by the number of pixels, and the discharge cell size is also determined by the number of pixels.

Referring to FIG. 2, the scan electrodes 21 and the sustain electrodes 23 of the display electrodes 25 provide a discharge gap (g) corresponding to each discharge cell 18.

The scan electrodes 21 and the sustain electrodes 23 are extended with the discharge gap (g), of a predetermined distance, therebetween in a first direction. The scan electrodes 21 and the sustain electrodes 23 are thin membranes formed on the surface of the front substrate 20 facing the rear substrate 10, and each includes a belt-shaped transparent electrode 211 and 231 and a stripe-shaped bus electrode 213 and 233 formed on the transparent electrodes 211 and 231. The display electrodes 25 having such a structure are formed above the discharge cells 18.

The bus electrodes 213 and 233 include a conductive material such as copper (Cu) or silver (Ag), and the transparent electrodes 211 and 231 include a transparent material such as ITO so that the surface of the discharge cells 18 may not be blocked. The bus electrodes 213 and 233 and the transparent electrodes 211 and 231 are thin membranes formed on the surface of the front substrate 20 facing the rear substrate and are disposed to correspond to each discharge cell 18.

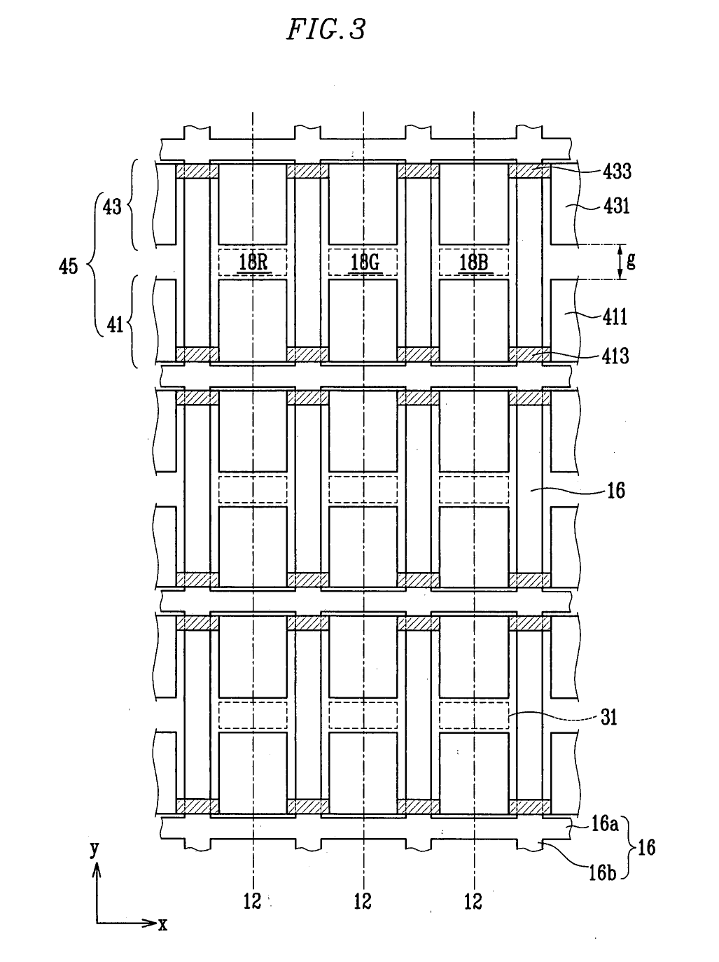

FIG. 3 illustrates a second embodiment of the present invention. Display electrodes 45 include scan electrodes 41 and sustain electrodes 43. The scan electrodes 41 and sustain electrodes 43 include stripe-type bus electrodes 413 and 433 and protrusion electrodes 411 and 431 electrically connected to the bus electrodes 413 and 433 and protruding inside each discharge cell 18.

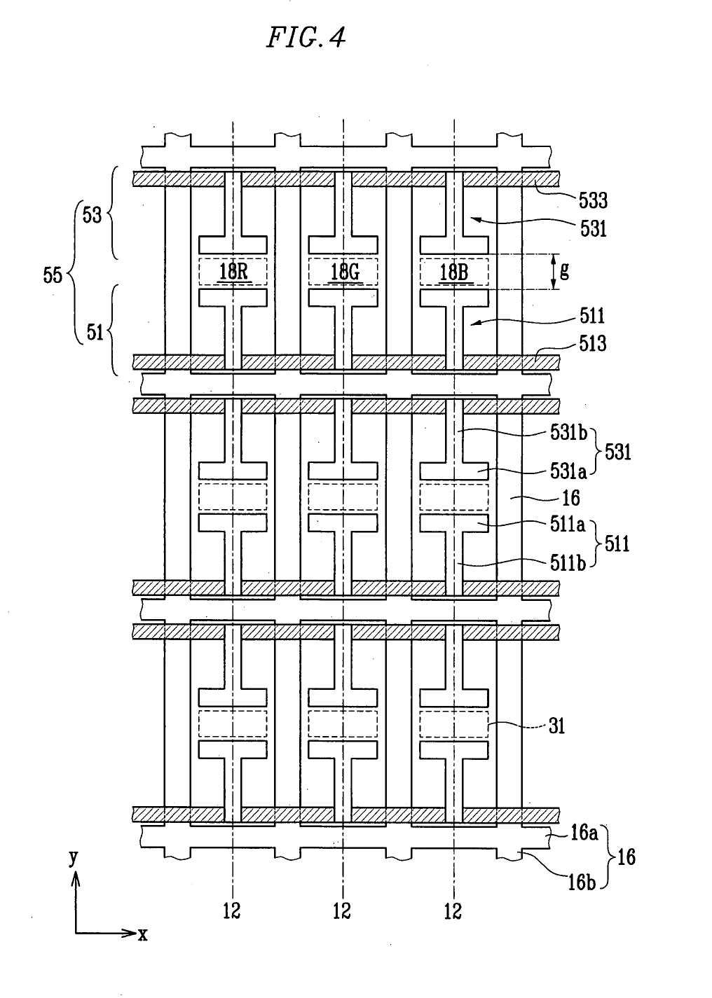

FIG. 4 illustrates a third embodiment of the present invention. Display electrodes 55 include scan electrodes 51 and sustain electrodes 53. The scan electrodes 51 and sustain electrodes 53 include stripe-type bus electrodes 513 and 533 and protrusion electrodes 511 and 531 electrically connected to the bus electrodes 513 and 533 and protruding inside the discharge cells 18. The protrusion electrodes 511 and 531 include stripe-type terminal end parts 511a and 531a having a predetermined distance from the adjacent terminal end part to provide a discharge gap g, and stripe-type connection parts 511b and 531b connecting the terminal end parts 511a and 531a to the bus electrodes 513 and 533. The terminal end parts 511a and 531a and the connection parts 511b and 531b are extended in a first direction and in a second direction, respectively. Accordingly, the protrusion electrodes 511 and 531 are ‘T’ shaped in the plan view.

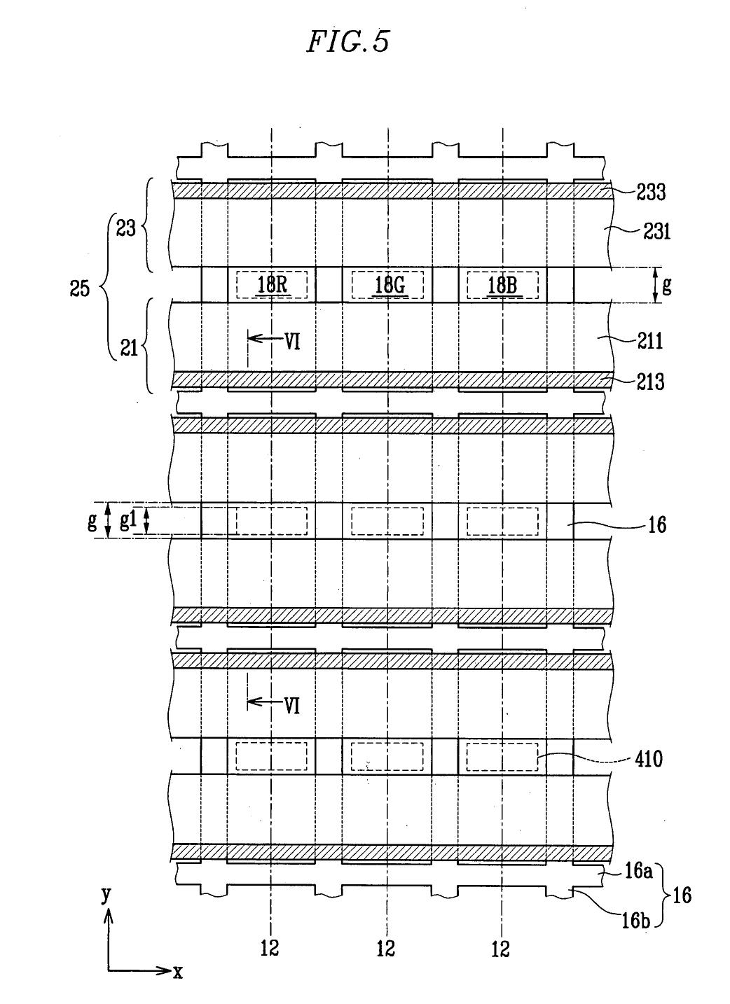

FIG. 5 illustrates a fourth embodiment of the present invention. Between the scan electrodes 21 and the sustain electrodes 23, groove parts 410 are formed on the dielectric layer 28. The groove parts 410 are formed between the scan electrodes 21 and the sustain electrodes 23 and decrease the discharge initial voltage.

The groove parts 410 are formed in the discharge gap g between the scan electrodes 21 and the sustain electrodes 23. The width g1 of the groove parts 410 in the second direction is smaller than that of the discharge gap g.

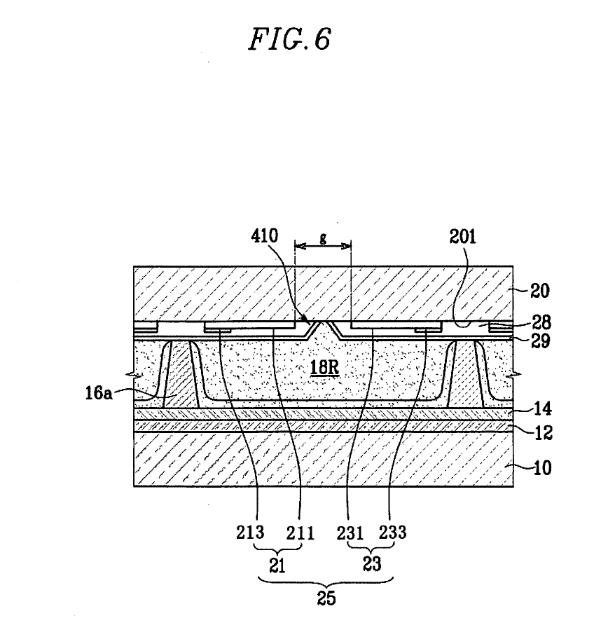

Hereinafter, the dielectric layer 28 is described referring to FIG. 6. FIG. 6 is a cross-sectional view showing a cross-section cut along the VI-VI line of FIG. 5.

As shown in FIG. 6, the display electrodes 25 are covered with and protected by the dielectric layer 28 including a dielectric material. The dielectric layer 28 is formed of a dielectric material (PbO, B₂O₃, SiO₂ and so on) and deposited on the facing surface 201 of the front substrate 20, and is transparent so that the visible light generated from the discharge gas of the discharge cells 18 may not be blocked.

The groove parts 410 are formed on the dielectric layer 28. The groove parts 410 are formed in the discharge gap g between the scan electrodes 21 and the sustain electrodes 23. Accordingly, the groove parts 410 are disposed in the spaces between the scan electrodes 21 and the sustain electrodes 23. Since, due to the groove parts 410, the electric flux between the scan electrodes 21 and the sustain electrodes 23 is formed in a direct line during the discharge, the electric flux density is increased to thereby decrease the initial voltage, as compared to the conventional plasma display panel.

A fifth embodiment of the present invention relates to a PDP that provides a resolution of 1920×1080, which can be applied to any structure, and so a detailed description referring to a drawing is omitted.

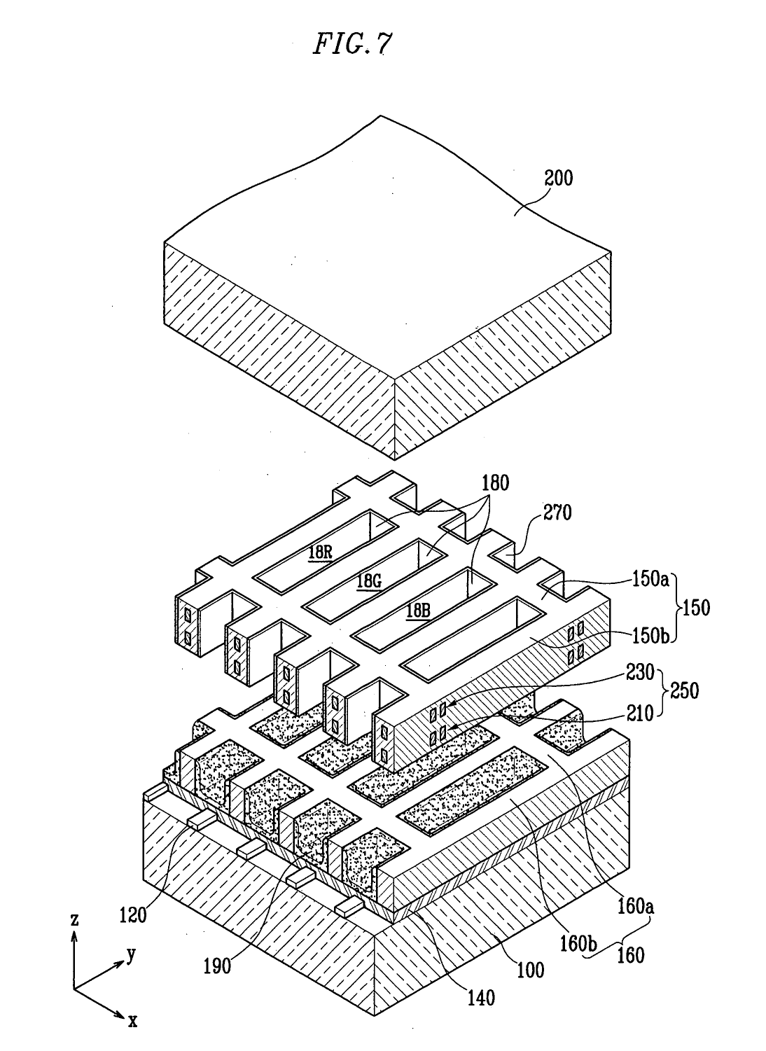

Hereinafter, the PDP according to the sixth embodiment is described with reference to FIG. 7. FIG. 7 is an exploded perspective view showing a partial portion of a PDP according to a sixth embodiment of the present invention.

According to the sixth embodiment, first barrier ribs 150 and second barrier ribs 160 are assembled between a front substrate 200 and a rear substrate 100 to partition discharge cells 180, and display electrodes 250 are covered with the first barrier ribs 150 to surround the circumference of the discharge cells 180.

The front substrate 200 is formed by a transparent glass substrate for transmitting the visible light and is disposed to face the rear substrate 100.

The first barrier ribs 150 are formed on the front substrate 200. The first barrier ribs 150 cover the display electrodes 250 and include horizontal barrier ribs 150a extending in a first direction and vertical barrier ribs 150b extending in a second direction crossing the first direction.

The display electrodes 250 include scan electrodes 210 selecting discharge cells 180 to be turned on when operated with address electrodes 120 and sustain electrodes 230 generating sustain discharges in the selected discharge cells 180. In the direction from the front substrate 200 to the rear substrate 100, the sustain electrodes 230 and the scan electrodes 210 are buried in the first barrier ribs 150. The scan electrodes 210 and the sustain electrodes 230 extend in a first direction and surround the circumference of the discharge cells 180 for each discharge cell 180.

Since both the scan electrodes 210 and the sustain electrodes 230 are buried in the first barrier ribs 150 formed of the dielectric material such as PbO, B₂O₃, SiO₂ and so on, the first barrier ribs 150 prevent the scan electrodes 210 and the sustain electrodes 230 from electrically connecting with each other. The first barrier ribs 150 also prevent the charged particles from colliding with the display electrodes 250 and induce the charged particles to accumulate a wall charge.

According to one embodiment, the wall surfaces of the first barrier ribs 150 are covered with a protective layer 270. The protective layer 270 prevents the charged particles from colliding with the first barrier ribs 150 and releases secondary electrons during the discharge.

Second barrier ribs 160 are formed on the rear substrate 100 and include horizontal barrier ribs 160a and vertical barrier ribs 160b, as like the first barrier ribs 150. On the second barrier ribs 160, phosphors are coated to provide a phosphor layer 190 on the bottom surface and the wall surfaces of the second barrier ribs 160. The phosphor layer is formed from the phosphor composition according to the embodiment of the present invention and includes phosphors and the firing promoter.

Since the first barrier ribs 150 are disposed direct on the second barrier ribs 160, the PDP according to the sixth embodiment include discharge cells 180 that are provided by assembling the first barrier ribs 150 covering the display electrodes 250 with the second barrier ribs 160 having the phosphor layer 190.

On the rear substrate 100 facing the front substrate 200, the address electrodes 120 are formed. The address electrodes 120 cross the display electrodes 250 and extend in a second direction to correspond to each discharge cell 180. The address electrodes 120 are disposed in parallel. Accordingly, in looking at the whole rear substrate 100, the address electrodes 120 form a stripe pattern. The address electrodes 120 are operated with the scan electrodes 210 and select discharge cells 180 to be turned on.

As mentioned above, since the scan electrodes 210 are covered with the first barrier ribs 150 closer to the rear substrate 100, the distance between the scan electrodes 210 and the address electrodes 120 is smaller, thereby realizing an addressing drive that turns on the selected discharge cells at a low voltage. Since the phosphor layer 190 is formed on the second barrier ribs 160 and the display electrodes 250 are covered with the first barrier ribs 150 thereon, the distance between the phosphor layer 190 and the display electrodes 250 is smaller, and so the luminous efficiency and the luminance are improved.

The address electrodes 120 are covered with and protected by a dielectric layer 140. The second barrier ribs 160 are formed thereon, and then the phosphor layer 190 is covered thereon.

The phosphor layer 190 is provided by coating the phosphor composition on the bottom surface and the wall surfaces of the second barrier ribs 160, and firing the phosphor composition. The phosphor layer 190 is formed on each red R, green G, and blue B color discharge cells to display an image. A set of a red discharge cell 18R, a green discharge cell 18G, and a blue discharge cell 18B forms one pixel.

The inside of the discharge cells 180 is filled with a mixed discharge gas of neon, xenon, and so on.

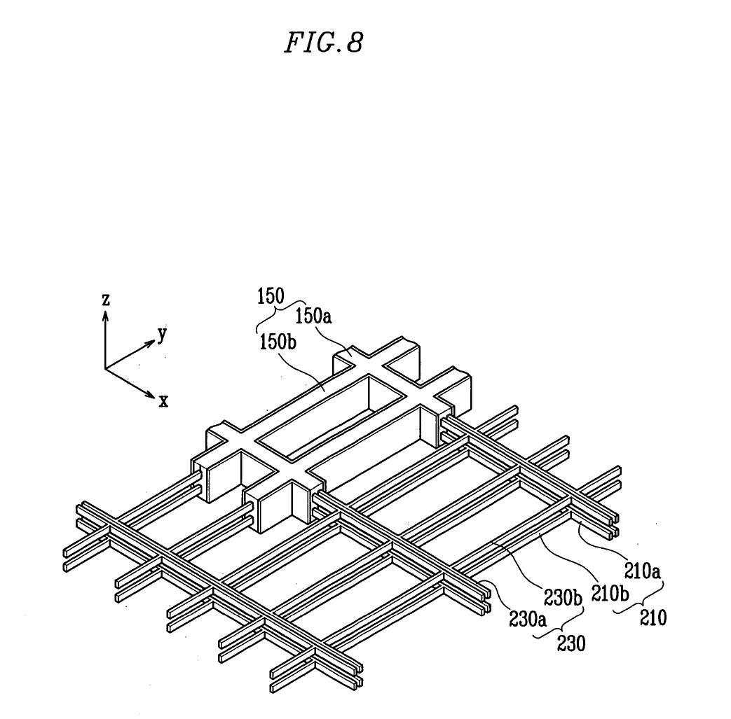

Hereinafter, the discharge cell structure of the PDP according to the sixth embodiment is described referring to FIG. 8 to FIG. 12.

Referring to FIG. 8, the display electrode of the PDP according to the sixth embodiment will be described.

The display electrodes 250 are buried in the first barrier ribs 150, and the first barrier ribs 150 are disposed on the front substrate 200 in the space between the front substrate 200 and the rear substrate 100. The first barrier ribs 150 include horizontal barrier ribs 150a extending in a first direction and vertical barrier ribs 150b extending in a second direction to partition discharge cells as a lattice. Thereby, the display electrodes are disposed on an upper part of each discharge cell to surround the circumference of the discharge cells.

The display electrodes 250 are buried in the first barrier ribs 150 in the order of the sustain electrodes 230 and the scan electrodes 210 in view of the direction toward the rear substrate 100, and extend in the first direction.

In the sixth embodiment, the sustain electrodes 230 are adjacent to the front substrate 100 and are buried in the first barrier ribs 150. The scan electrodes 210 are disposed to leave a distance under the sustain electrodes 230.

Each of the scan electrodes 210 and the sustain electrodes 230 includes stripe type line electrodes 210a and 230a buried in the horizontal barrier ribs 150a and stripe type connection electrodes 210b and 230b buried in the vertical barrier ribs 150b crossing the horizontal barrier ribs 150a.

Each of the line electrodes 210a and 230a is formed in the horizontal barrier ribs 150a and is extended in the same direction as the horizontal barrier ribs 150a. The line electrodes 210a and 230a have a stripe shape having a rectangular cross-section, and these line electrodes 210a and 230a are disposed to leave a gap in a z-axis direction, as shown in FIG. 8.

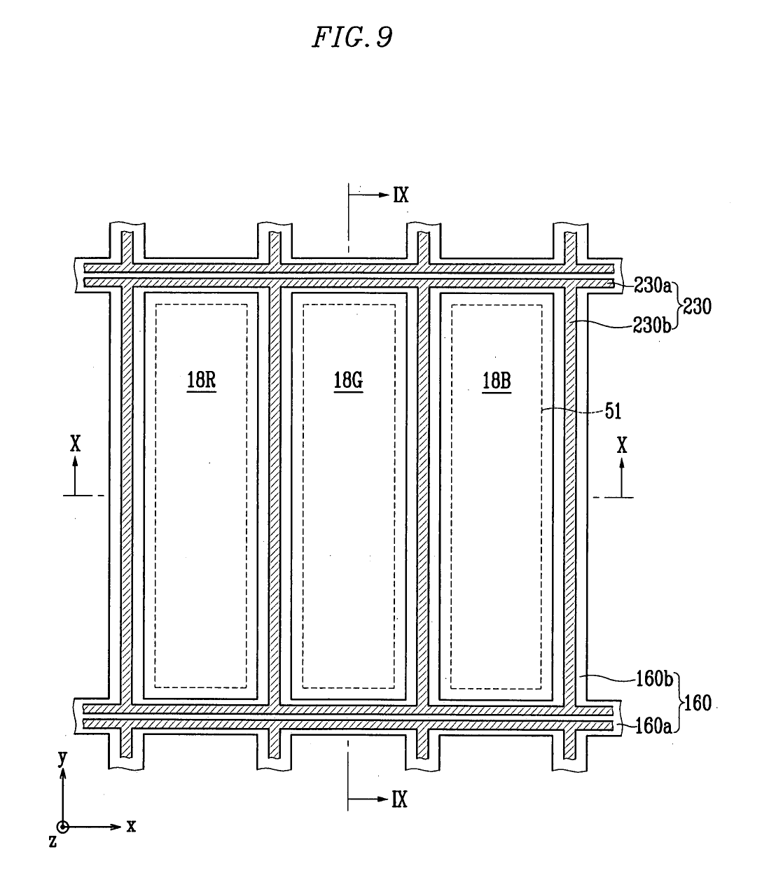

The line electrodes 210a and 230a are formed in pairs in one horizontal barrier rib 150a to correspond to each discharge cell. The line electrodes 210a and 230a are facing each other in the z-axis direction alongside a discharge cell (referring to FIG. 8 and FIG. 9).

The connection electrodes 210b and 230b are formed in the vertical barrier ribs 150b and connect adjacent pairs of line electrodes 210a and 230a to surround the discharge cells. The connection electrodes 210b and 230b form a stripe shape having a rectangular cross-section, as like the line electrodes 210a and 230a, and these connection electrodes 210b and 230b are disposed to leave a gap in the z-axis direction, as shown in FIG. 8. The connection electrodes 210b and 230b are facing each other in the x-axis direction alongside a discharge cell (referring to FIG. 8 and FIG. 9).

The scan electrodes 210 and the sustain electrodes 230 are formed to surround the circumference of the discharge cells by assembling the line electrodes 201a and 230a and the connection electrodes 210b and 230b. They form a rectangular plane shape along the circumference of the discharge cells and form a lattice when looking at the whole PDP.

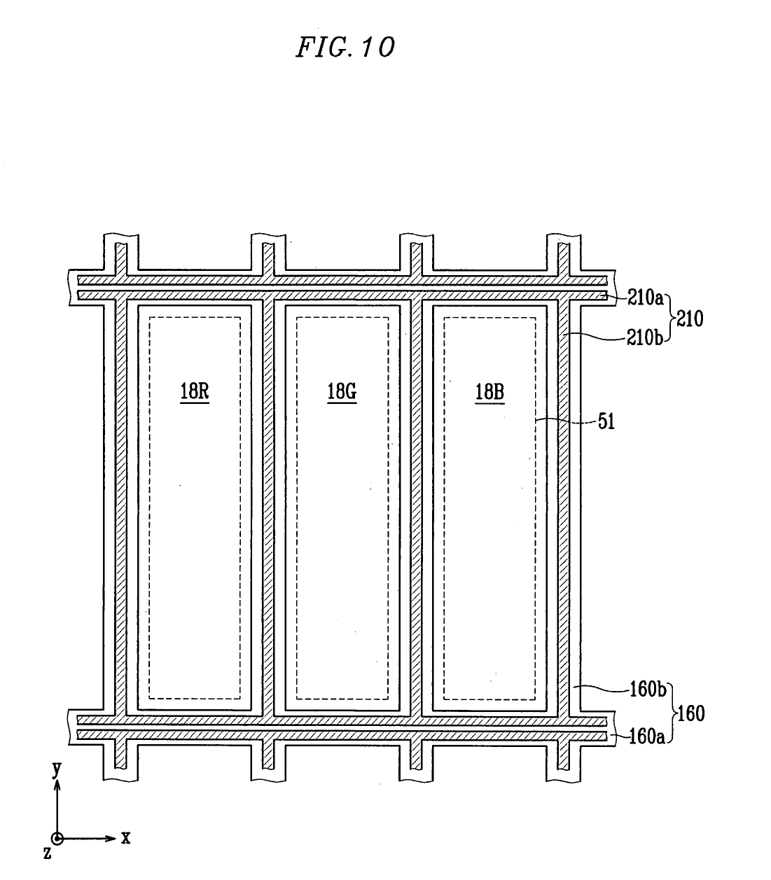

Since the sustain electrodes 230 and the scan electrodes 210 are buried in the first barrier ribs 150 in sequence in the z-axis direction in FIG. 10, they are facing each other in the z-axis direction of FIG. 10.

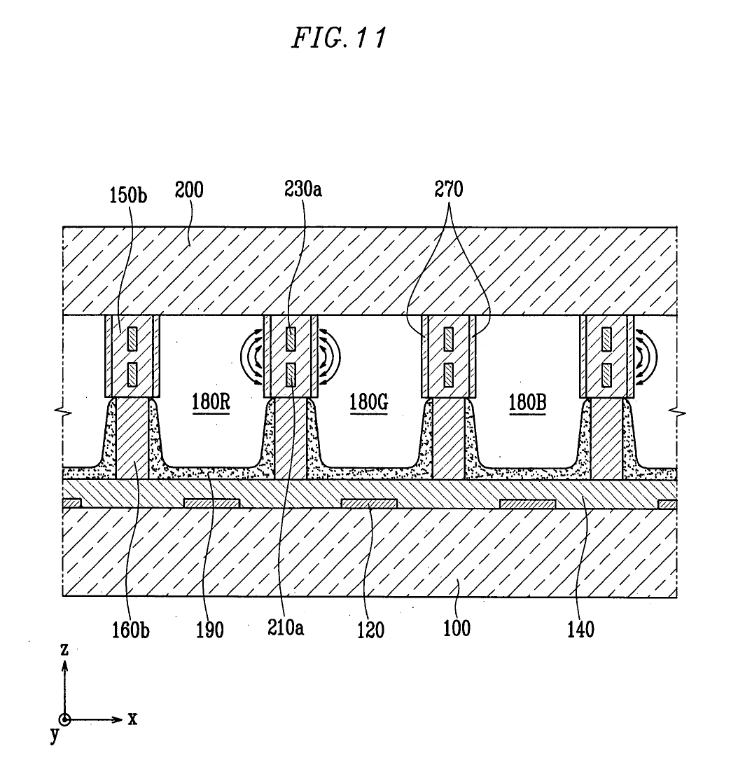

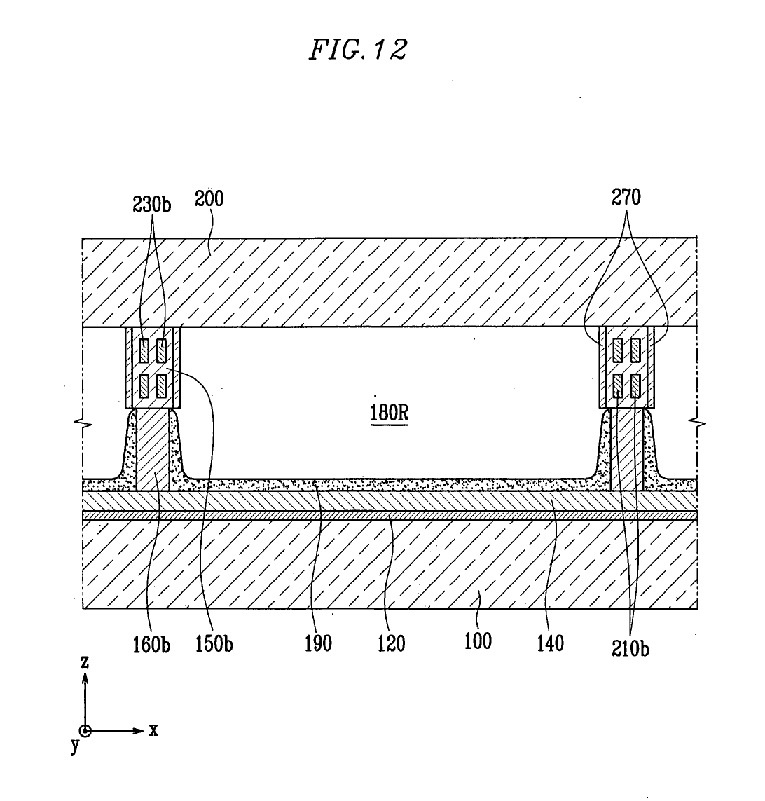

FIG. 11 is a cross-sectional view showing a cross-section cut along the line X-X of FIG. 9, and FIG. 12 is a cross-sectional view showing a cross-section cut along the line IX-IX of FIG. 9.

As shown in the drawings, the discharge cells are partitioned by assembling the first barrier ribs 150b and the second barrier ribs 160b having the same shape as the first barrier ribs 150b and disposed under the first barrier ribs 150b.

The first barrier ribs 150b are disposed on the front substrate 200, while the second barrier ribs 160b are disposed on the rear substrate 100. Thereby, the display electrodes, i.e., the line electrodes 210a and 230a (FIG. 11) and the connection electrodes 210b and 203b, are disposed above the discharge cells 180, and the phosphor layer 190 is disposed on the bottom surface and wall surfaces of the discharge cells 180.

According to the sixth embodiment, the display electrodes are buried in the first barrier ribs 150b, and the phosphor layer 190 is partially formed on the bottom surface and the wall surfaces of the second barrier ribs 160b. Thereby, the display electrodes surround the circumference of the discharge cells 180 above the discharge cells 180. The phosphor layer 190 is disposed under the display electrodes.

The following examples illustrate the present invention in more detail. However, it is understood that the present invention is not limited by these examples.

### EXPERIMENTAL EXAMPLES

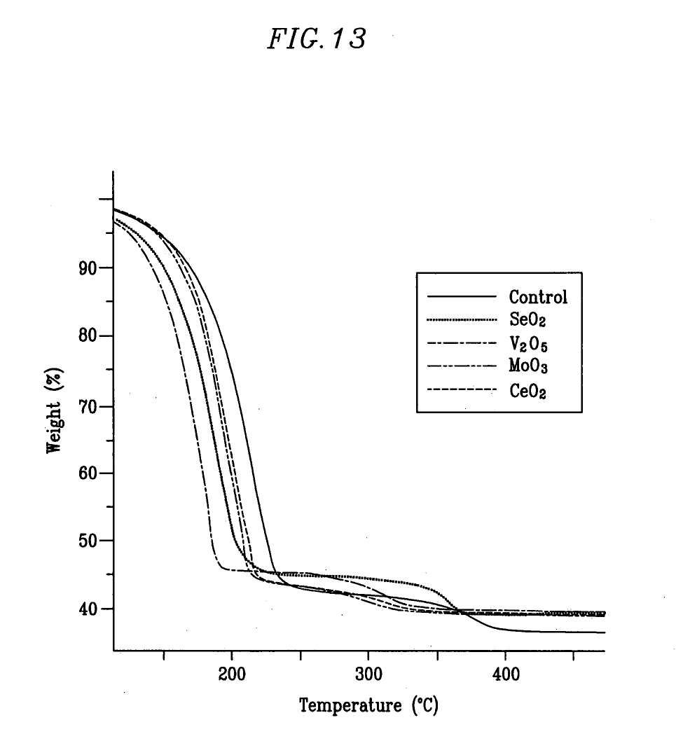

In order to measure the thermo decomposition characteristics of SeO₂, V₂O₅, MoO₃, and CeO₂, 2 g of each was mixed with 40 g of BaMgAl₁₀O₁₇:Eu²⁺ blue phosphor, 52 g of a mixed organic solvent of butyl carbitol acetate and terpineol (mixing weight ratio of 30:70), and 6 g of an ethylene cellulose (EC) organic binder. The mixture was subjected to thermogravimetric analysis (TGA). The TGA analysis was performed under the condition of isothermal increasing at a speed of 10° C./min. The results are shown in FIG. 13. For the comparison, an organic binder of ethylene cellulose (EC) was mixed with a mixed solvent of butyl carbitol acetate and terpineol (mixing weight ratio of 30:70) to provide a control, and the TGA analysis results are shown in FIG. 13. In FIG. 13, wt % in the y-axis stands for the remaining amount of paste after thermo decomposition.

As shown in FIG. 13, the paste including SeO₂, V₂O₅, MoO₃, or CeO₂ has a sharper thermo decomposition curve than that of the control. In particular, the SeO₂ and V₂O₅ components contribute to fast decomposition, and the MoO₃ and CeO₂ components contribute to lower decomposition temperatures. From the results, it is estimated that a residual carbon of the polymer resin may be effectively removed from the paste when these components are suitably included in the paste so that luminous efficiency and luminance maintenance ratio can be improved.

### Examples 1 to 8, and Reference Examples 1 to 7

580 g of an organic binder of ethylene cellulose (EC) resin was dissolved in a mixed organic solvent of butyl carbitol acetate and terpineol (mixing weight ratio of 30:70), added with

4000 g of BaMgAl₁₀O₁₇:Eu²⁺ blue phosphor and a firing promoter, and agitated.

Then, the obtained mixture was kneaded with a 3-roll mill while the viscosity was adjusted to provide a blue phosphor paste for the plasma display panel. The amount of the organic solvent and the kind and amount of the firing promoter were changed as shown in the following Table 1.

The paste was printed on the surface of the barrier ribs of the rear substrate, dried and fired, and then the panel was assembled, sealed, degassed, injected with gas, and aged to provide a plasma display panel.

### Comparative Example 1

The process was performed in accordance with the same procedure as in Example 1 except that the firing promoter was not used.

TABLE 1

| | | polymer | | | |
|---|---|---|---|---|---|
| | phosphor | resin | firing promoter | | organic |
| (unit: g) | powder | (EC) | Kind | amount | solvent |
| Com- | 4000 | 580 | — | — | 5420 |
| parative | | | | | |
| Example 1 | | | | | |
| Example 1 | 4000 | 580 | SeO₂ | 10 | 5410 |
| Reference | 4000 | 580 | V₂O₅ | 15 | 5405 |
| Example 1 | | | | | |
| Reference | 4000 | 580 | MoO₃ | 15 | 5405 |
| Example 2 | | | | | |
| Reference | 4000 | 580 | CeO₂ | 20 | 5400 |
| Example 3 | | | | | |
| Example 2 | 4000 | 580 | SeO₂, V₂O₅ | 20 | 5400 |
| | | | (1:1 weight ratio) | | |
| Reference | 4000 | 580 | MoO₃, CeO₂ | 25 | 5395 |
| Example 4 | | | (1:1 weight ratio) | | |
| Example 3 | 4000 | 580 | SeO₂, CeO₂ | 30 | 5390 |
| | | | (1:1 weight ratio) | | |
| Reference | 4000 | 580 | V₂O₅, MoO₃ | 30 | 5390 |
| Example 5 | | | (1:1 weight ratio) | | |
| Example 4 | 4000 | 580 | SeO₂, MoO₃ | 25 | 5395 |
| | | | (1:1 weight ratio) | | |
| Reference | 4000 | 580 | V₂O₅, CeO₂ | 30 | 5390 |
| Example 6 | | | (1:1 weight ratio) | | |
| Example 5 | 4000 | 580 | SeO₂, V₂O₅, MoO₃ | 35 | 5385 |
| | | | (1:1:1 weight ratio) | | |
| Example 6 | 4000 | 580 | SeO₂, V₂O₅, CeO₂ | 40 | 5380 |
| | | | (1:1:1 weight ratio) | | |
| Example 7 | 4000 | 580 | SeO₂, MoO₃, CeO₂ | 45 | 5375 |
| | | | (1:1:1 weight ratio) | | |
| Reference | 4000 | 580 | V₂O₅, MoO₃, CeO₂ | 50 | 5370 |
| Example 7 | | | (1:1:1 weight ratio) | | |
| Example 8 | 4000 | 580 | SeO₂, V₂O₅, MoO_{3,} | 50 | 5370 |
| | | | CeO₂ | | |
| | | | (1:1:1:1 weight | | |
| | | | ratio) | | |

Phosphor pastes obtained from Examples 1 to 7 Comparative Example 1, and Reference Examples 1 to 8 were used to provide plasma display panels having the same structure as shown in FIG. 3. At this time, the amount (g) of the firing promoter in the obtained phosphor layer was substantially similar with the used amount. That is, in order to prove that the new material effectively removes the residual carbon and improves the luminous efficiency and the luminance maintenance ratio, all processes and firing temperatures were carried out under the same conditions. The obtained plasma display panels were measured for a residual carbon amount, early luminance, luminance maintenance ratio, and dark spots increase compared to the early stage, and the results are shown in the following Table 2.

Even though there are lots of residual carbon components deteriorating the phosphor, generally, the phosphor is easily deteriorated by a component having a C group. Among them, C, CO, CH(29), and CH(45) are considered as the most harmful residual carbon (wherein CH is hydrocarbon and the numbers indicate molecule weight). These components were measured by Total Dissolved Solid (TDS) analysis to find the remaining amount in the phosphor layer.

The early luminance was determined by measuring the panel's full white luminance (full white pattern of the front substrate). The average value of the panel luminance was taken from the panels fabricated under the same conditions. The reference luminance was determined by setting the luminance of Comparative Example 1 as 100% to easily explain the improved level. The measurement was performed with a CA-100plus contact luminance meter (manufactured by Minolta).

The luminance maintenance ratio was determined by comparing the initial luminance which is considered as 100% with the luminance after 500 hours. From the maximum luminance (initial luminance) of 100 IRE, 1% pattern of the total 100% pattern was made, and the life-span was measured every 100 hours. The result of this accelerated life-span can be obtained 1/7 times of that of the general motion picture life-span. In other words, the accelerated life-span has 50% luminance maintenance ratio for 2000 hours, and this means that the motion picture will have 50% luminance compared to the early luminance after 14000 hours.

The dark spots generation rate was determined to monitor the stability of the phosphor layer during the vibration falling. The tests were performed by vibrating the panel module in the vertical direction at 1.50 Grm for 2 hours, falling the same three times from 1 m height, and then counting the dark spots increase number. This was to figure out if the added material deteriorates the phosphor layer.

TABLE 2

| | | | | | | luminance | |
|---|---|---|---|---|---|---|---|
| | | | | | | maintenance | Increasing |
| | Residual carbon (ppm) | | | | Initial | ratio (after | ratio of |
| | C | CO | CH 29 | CH 45 | luminance | 500 hr) | black dots |
| Comparative | 5.41E−4 | 3.58E−3 | 2.16E−4 | 6.07E−5 | 100.0% | 82.1% | 0 |
| Example 1 | | | | | | | |
| Example 1 | 4.75E−6 | 1.82E−5 | 3.02E−6 | 4.92E−7 | 105.9% | 86.5% | 0 |
| Reference | 6.41E−6 | 2.51E−5 | 4.12E−6 | 7.23E−7 | 106.5% | 87.7% | 0 |
| Example 1 | | | | | | | |
| Reference | 6.15E−6 | 5.24E−5 | 5.32E−6 | 6.67E−7 | 105.8% | 86.4% | 0 |
| Example 2 | | | | | | | |
| Reference | 3.99E−6 | 4.35E−5 | 6.40E−6 | 6.84E−7 | 107.1% | 88.0% | 0 |
| Example 3 | | | | | | | |
| Example 2 | 5.62E−6 | 7.67E−5 | 2.62E−6 | 5.83E−7 | 109.0% | 87.4% | 0 |
| Reference | 5.34E−6 | 5.96E−5 | 6.79E−6 | 7.25E−7 | 108.6% | 86.1% | 0 |
| Example 4 | | | | | | | |
| Example 3 | 4.26E−6 | 6.84E−5 | 5.96E−6 | 4.69E−7 | 108.7% | 87.2% | 0 |
| Reference | 5.53E−6 | 6.78E−5 | 2.88E−6 | 1.74E−7 | 109.4% | 88.6% | 0 |
| Example 5 | | | | | | | |
| Example 4 | 1.85E−6 | 5.41E−5 | 3.57E−6 | 3.98E−7 | 107.8% | 86.5% | 0 |
| Reference | 1.77E−6 | 3.13E−5 | 1.25E−6 | 1.47E−7 | 110.3% | 88.8% | 0 |
| Example 6 | | | | | | | |
| Example 5 | 3.48E−6 | 2.28E−5 | 5.44E−6 | 5.57E−7 | 109.7% | 87.9% | 0 |
| Example 6 | 6.56E−6 | 7.55E−5 | 4.61E−6 | 4.16E−7 | 108.4% | 88.4% | 0 |
| Example 6 | 7.64E−6 | 4.64E−5 | 1.53E−6 | 5.59E−7 | 107.4% | 86.9% | 0 |
| Reference | 6.31E−6 | 6.93E−5 | 3.73E−6 | 7.81E−7 | 107.9% | 87.4% | 0 |
| Example 7 | | | | | | | |
| Example 8 | 7.25E−6 | 3.72E−5 | 5.34E−6 | 2.52E−7 | 108.2% | 88.0% | 0 |

As shown in Table 2, the plasma display panels according to Examples 1 to 8 including only SeO₂ or at least one of V₂O₅, MoO₃, and CeO₂ as well as SeO₂ increase the early luminance by 5.9 to 9.7% and the luminance maintenance ratio by 4.4 to 5.8% more than those of Comparative Example 1. This is because residual carbons (C, CO, CH 29, and CH 45) from the polymer resins were effectively removed. Similar effects were also obtained in Reference Examples 1 to 7 where the firing promoter includes at least one of V₂O₅, MoO₃, or CeO₂.

The plasma display panels according to Examples 1 to 8, Comparative Example 1, and Reference Examples 1 to 7 were measured for after-image maintenance time in a bright room and the after-image maintenance time in a dark room, and the result are shown in the following Table 3.

The analysis for detecting a residual image generally includes the analysis for detecting a residual image in a bright room and the analysis for detecting a residual image in a dark room. The analysis for detecting a residual image in a bright room was performed by, with a strength of 100 IRE, displaying a 3% pattern of the total 100% pattern for 1 minute and transferring to a F/W pattern. The result of the analysis for detecting a residual image was obtained by detecting the duration from the time when the discharged part can be distinguished from the non-discharged part to the time when they cannot be distinguished from each other. The analysis for detecting a residual image in a dark room was performed by, with a strength of 100 IRE, displaying a 3% pattern for 1 minute and transferring to a background state. The result of the analysis for detecting a residual image was obtained by detecting the duration from the time when the discharged part can be distinguished from the non-discharged part to the time when they cannot be distinguished from each other.

The residual image is generated by shift of impurities which is caused by the change of the temperature of the panel. This is because the temperature of the panel discharge part is higher than that of the non-discharge part. The shorter after-image time results in a higher image quality.

TABLE 3

| | After-image | |
|---|---|---|
| | maintenance time in a | After-image maintenance |
| | bright room | time in a dark room |
| Comparative | 150 sec | 240 sec |
| Example 1 | | |
| Example 1 | 30 sec | 80 sec |
| Reference | 60 sec | 105 sec |
| Example 1 | | |
| Reference | 55 sec | 100 sec |
| Example 2 | | |
| Reference | 50 sec | 95 sec |
| Example 3 | | |
| Example 2 | 25 sec | 70 sec |
| Reference | 60 sec | 110 sec |
| Example 4 | | |
| Example 3 | 30 sec | 75 sec |
| Reference | 50 sec | 100 sec |
| Example 5 | | |
| Example 4 | 28 sec | 70 sec |
| Reference | 55 sec | 105 sec |
| Example 6 | | |
| Example 5 | 29 sec | 75 sec |
| Example 6 | 30 sec | 80 sec |
| Example 7 | 24 sec | 70 sec |
| Reference | 50 sec | 100 sec |
| Example 7 | | |
| Example 8 | 21 sec | 65 sec |

As shown in Table 3, the phosphor composition according to Examples 1 to 7 including at least one of SeO₂, V₂O₅, MoO₃, and CeO₂ had an after-image maintenance time in a bright room and an after-image maintenance time in a dark room shorter than those according to Comparative Example 1. Particularly, in the cases of Examples 1 to 8 including SeO₂, the after-image maintenance time in a bright room and the after-image maintenance time in a dark room are remarkably decreased than those according to Reference Examples 1 to 7. From the results of Table 3, if the firing promoter includes SeO₂, V₂O₅, MoO₃, or CeO₂, image quality is improved compared with the case of no firing promoter. More particularly, when the firing promoter includes SeO₂, the image quality is much more improved. When the firing promoter includes all of SeO₂, V₂O₅, MoO₃, and CeO₂, the sensible image quality is most improved.

As described above, the phosphor composition according to one embodiment of the present invention can the improve luminous efficiency and the luminance maintenance ratio of a plasma display panel and decrease the firing temperature without damage of a panel by completely removing impurities such as a binder and a solvent when forming a phosphor layer due to a firing promoter.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A phosphor composition for a plasma display panel, comprising:
a phosphor;
a firing promoter comprised of SeO₂; and
a vehicle.

2. The composition of claim 1, wherein the firing promoter further comprises at least one oxide including an element selected from the group consisting of a group 6A element, a group 5B element, a group 6B element, a lanthanum-based element, and mixtures thereof.

3. The composition of claim 2, wherein the oxide is selected from the group consisting of V₂O₅, MoO₃, CeO₂, and mixtures thereof.

4. The composition of claim 1, wherein the firing promoter comprises SeO₂, V₂O₅, MoO₃, and CeO₂.

5. The composition of claim 1, wherein the phosphor composition comprises 0.1 to 10 wt % of the firing promoter based on the total weight of the phosphor composition.

6. The composition of claim 5, wherein the phosphor composition comprises 0.1 to 5 wt % of the firing promoter based on the total weight of the phosphor composition.

7. The composition of claim 1, wherein the vehicle comprises a binder and a solvent.

8. A plasma display panel comprises:
a first substrate and a second substrate facing each other;
discharge cells partitioned in a space between the first and second substrates;
a phosphor layer disposed in the discharge cells, the phosphor layer including a phosphor and a firing promoter comprised of SeO₂;
display electrodes forming a discharge gap in each discharge cell;
a dielectric layer covering the scan electrodes and the sustain electrodes; and
address electrodes disposed in a direction crossing the scan electrodes and the sustain electrodes.

9. The plasma display panel of claim 8, wherein the firing promoter further comprises at least one oxide including an element selected from the group consisting of a group 6A element, a group 5B element, a group 6B element, a lanthanum-based element, and mixtures thereof.

10. The plasma display panel of claim 9, wherein the oxide is selected from the group consisting of V₂O₅, MoO₃, CeO₂, and mixtures thereof.

11. The plasma display panel of claim 8, wherein the firing promoter comprises SeO₂, V₂O₅, MoO₃, and CeO₂.

12. The plasma display panel of claim 8, wherein the phosphor layer comprises 0.25 to 25 wt % of the firing promoter based on the total weight of the phosphor layer.

13. The plasma display panel of claim 12, wherein the phosphor layer comprises 2.5 to 12.5 wt % of the firing promoter based on the total weight of the phosphor layer.

14. A method for preparing a phosphor layer in a plasma display panel, comprising:
preparing a phosphor composition comprising a phosphor, a firing promoter comprised of SeO₂, and a vehicle;
coating the phosphor composition on barrier ribs of the plasma display panel; and
firing the phosphor composition coated on the barrier ribs to remove the vehicle.

15. The method of claim 14, wherein the firing promoter further comprises at least one oxide including an element selected from the group consisting of a group 6A element, a group 5B element, a group 6B element, a lanthanum-based element, and mixtures thereof.

16. The method of claim 15, wherein the oxide is selected from the group consisting of V₂O₅, MoO₃, CeO₂, and mixtures thereof.

17. The method of claim 14, wherein the firing promoter comprises SeO₂, V₂O₅, MoO₃, and CeO₂.

18. The method of claim 14, wherein the firing is performed at a temperature in the range of 400 to 460° C.

19. The method of claim 14, wherein the vehicle comprises a binder and a solvent.

20. A plasma display panel having the phosphor layer prepared by the method of claim 14.
